(19) United States
(12) Patent Application Publication
(10) Pub. No.: US 2023/0394878 A1
(43) Pub. Date: Dec. 7, 2023

(54) PROGRAM, INFORMATION PROCESSING DEVICE, AND METHOD

(71) Applicant: THEATER GUILD INC., Tokyo (JP)

(72) Inventor: Sotaro IGARASHI, Tokyo (JP)

(73) Assignee: THEATER GUILD INC., Tokyo (JP)

(21) Appl. No.: 18/248,683

(22) PCT Filed: Jul. 16, 2021
(86) PCT No.: PCT/JP2021/026847

§ 371 Date: Apr. 11, 2023

(30) Foreign Application Priority Data
Oct. 27, 2020 (JP) 2020-179455

(51) Int. Cl. G06V 40/16; G06V 10/75

(52) U.S. Cl. CPC G06V 40/174; G06V 40/172; G06V 10/75

(57) ABSTRACT

The server 20 of the video providing system 1 comprises: a camera capturing control module 2034 that captures viewers with a camera 40 and acquires the captured image data; a viewer identification module 2035 that identifies viewers individually and links them with viewer information stored in the viewer database 2021; a viewing state acquisition module 2036 that analyzes image data to acquire viewing state information indicating the viewing state of each viewer and associates it with viewer information; and a viewer matching module 2037 that matches viewers who are simultaneously viewing video content at a facility based on the viewing state information.

The present disclosure relates to a program, information processing device, and a method.

### BACKGROUND ART

In recent years, movie theaters and other facilities that provide visual content such as movies have been faced with the challenge of how to maximize the number of viewers (audience) they can attract. One of the reasons for this is that the widespread use of video content distribution services, the low cost of video content, and the use of larger televisions in the home have made it possible to view high-quality video content at home, eliminating the need to visit movie theaters. In addition, the recent coronavirus has further contributed to this trend.

As a result, new and different approaches have been observed, for example, showing video content in cafes and other restaurants to expand new audiences.

In addition, Patent Document 1 discloses technology for a reproduction system that changes the content of the video according to the viewer's psychological state during the reproduction of the video. The reproduction system described in the Patent Document 1 detects the viewer's biometric information and is configured to select and reproduce a video from different storylines according to the viewer's biometric information.
Patent Document 1: JP-A-2014-053672

### SUMMARY

### Technical Problem

By the way, viewers who have enjoyed high-quality video content want to share their impressions of the video content with others. For example, viewers may share their impressions of video content with others by posting their comments on SNSs. However, it is against manners to post something that could reveal the contents of the video (so-called spoilers) in a place where people who have not viewed the video content may access. Therefore, at facilities such as movie theaters, enabling people who have viewed video content at the same time to connect with each other and to discuss their impressions will satisfy their wish to share their feelings.

The present disclosure therefore describes a technology that enables connecting viewers who have viewed video content at facilities such as movie theaters.

### Solution to Problem

According to one embodiment of the disclosure, a program for execution by a computer equipped with a processor and a memory is provided. The program is configured to cause the memory to store viewer information that is registered as a viewer who views a video at a facility where the video is shown; and the program is configured to cause the processor to execute a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.

According to another embodiment of the present disclosure, there is provided an information processing device comprising a control unit and a memory unit. The memory unit stores viewer information that is registered as a viewer who views a video at a facility where the video is shown; and the control unit executes a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.

Furthermore, according to another embodiment of the present disclosure, there is provided a method for execution by a computer provided with a processor and a memory. The method comprises a memory storing viewer information that is registered as a viewer who views a video at a facility where the video is shown; and the method comprises a processor executing a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.

According to the present disclosure, the information processing device acquires viewing state information indicating the viewing state of each viewer and performs matching among viewers at the facility based on the viewing state information. This enables connecting viewers who have viewed the video at the facility.

### FIGURES

FIG. 1: Overall structure of the video providing system 1.

FIG. 2: A bird's-eye view showing an example of the exterior of a facility in which the video providing system 1 is installed.

FIG. 3: A block diagram showing the functional configuration of terminal device 10, which constitutes the video providing system 1 of the Embodiment 1.

FIG. 4: A block diagram showing the functional configuration of the server 20, which constitutes the video providing system 1 of the Embodiment 1.

FIG. 5: A schematic diagram showing a specific method of identifying viewers in the viewer identification module 2035 of FIG. 4.

FIG. 6: A schematic diagram showing the method of acquiring the lacrimal gland state indicating the viewing state in the viewing state acquisition module 2036 of FIG. 4.

FIG. 7: The data structure of the viewer database 2021 and the video content database 2022 stored by the server 20.

FIG. 8: A flowchart showing an example of the flow of the viewer identification process by the video providing system 1 of the Embodiment 1.

FIG. 9: A flowchart showing an example of the process of acquiring the viewing state using the video providing system 1 of the Embodiment 1.

FIG. 10: A flowchart showing an example of the flow of the viewer matching process using the video providing system 1 of the Embodiment 1.

FIG. 11: An example of a screen of the terminal device 10 that notifies the matching partner in the viewer matching process.

FIG. 12: Another example of a screen of the terminal device 10 that notifies the matching partner in the viewer matching process.

FIG. 13: An example of a screen of the terminal device 10 that notifies the meeting place in the viewer matching process.

FIG. 14: A block diagram showing the functional configuration of server 20, which constitutes the video providing system 1 of the Embodiment 2.

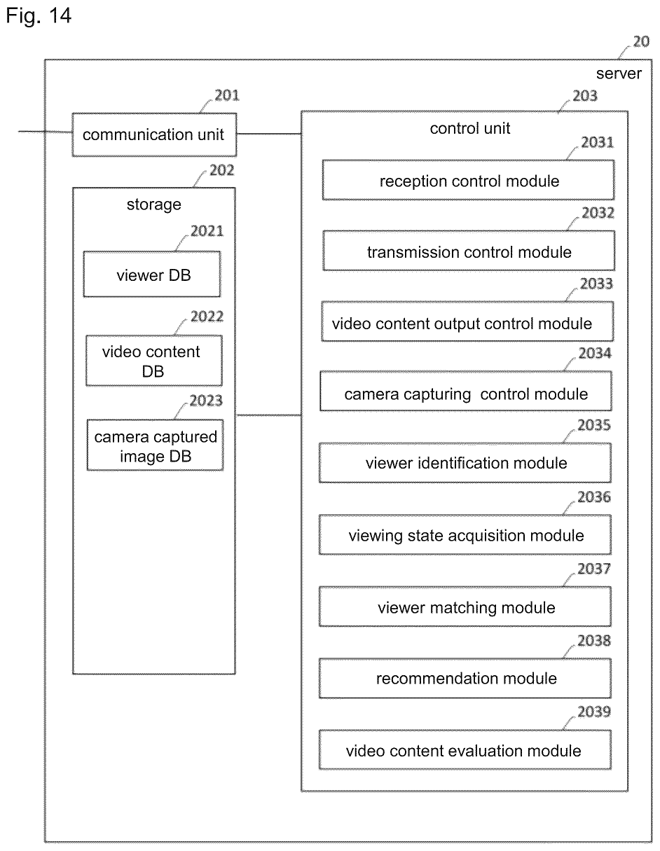

### DETAILED DESCRIPTION

Below is a description of the present disclosure with reference to the drawings. In the following description, identical components are marked with the same symbol. Their names and functions are also the same. Therefore, a detailed explanation of them will not be repeated.

<Overview>

In the following, the process of acquiring viewing state information of viewers who have viewed video content and matching viewers with each other in the video providing system will be explained. The video providing system displays (shows) video content such as movies at facilities such as movie theaters to provide viewers with opportunities to view the content, captures images of viewers viewing the content, analyzes the viewing state of viewers based on the captured image data, and matches viewers with each other.

Viewers of video content are considered to increase their level of concentration when they find the video content interesting and enjoyable, and to decrease their level of concentration by becoming distracted when they find the video content boring and tedious. It is known empirically that when a person viewing something (not only video content) is concentrating on the subject, the eyes (eyelids) open wider and the blinking frequency decreases. Therefore, when a viewer who is viewing video content shows the above responses, the viewer is considered to be concentrating on the viewing of that video content. In addition, if the viewer is concentrating on viewing the video content, the viewer is considered to be highly satisfied with that video content. Accordingly, by capturing and analyzing the viewing state of viewers, it is possible to estimate the viewer's level of concentration on and the level of satisfaction with the video content.

It is known empirically that viewers who are watching video content are likely to tear up when they find the story of the video content sad and sorrowful, their eyes become bloodshot, and tears accumulate in their lachrymal glands. Therefore, by analyzing the viewer's facial state, the viewer's current emotion and state of waking/sleeping can be estimated.

Therefore, the video providing system of the present disclosure uses a camera to capture viewers watching video content, and detects each viewer's face by identifying the viewer's face from the captured image data. Based on the state of the viewer's face in the image data, the system analyzes facial expressions, the state of the eyes, and the state of the lacrimal gland, and acquires information indicating the viewer's state of waking/sleeping, the viewer's level of concentration on the video content, the viewer's level of satisfaction, and the viewer's emotional state, and associates this information to viewing state information. This configuration enables viewing state information, such as the viewer's level of concentration, level of satisfaction, and emotion toward the video content, based on the viewer's facial reactions, to be associated to the viewer information.

The video providing system of the present disclosure is also configured to match viewers with each other based on the viewing state information of the viewers to the video content. By analyzing the viewing state information of viewers who viewed the video content at the same time at facilities such as movie theaters, it is possible to determine which scene caused the viewers to change their emotions or concentrate on. Therefore, viewers who responded in the similar manner are likely to share their impressions with each other. Therefore, by matching viewers who exhibit similar viewing state information, the viewers are able to talk about their impressions and sympathize with each other. To enable such a configuration, viewers are required to be registered as members and their information is registered. This configuration enables to connect and symphasize viewers with each other, who have similar impressions of the same movie. This provides new value to movie theaters.

Furthermore, the video providing system of the present disclosure identifies each viewer who is viewing the video content and associates them to the viewer information. This enables the system to acquire viewing state information for each viewer attribute type and to evaluate the video content.

### Embodiment 1

The following is a description of the video providing system 1.

<1. Overall Configuration of Video Providing System 1>

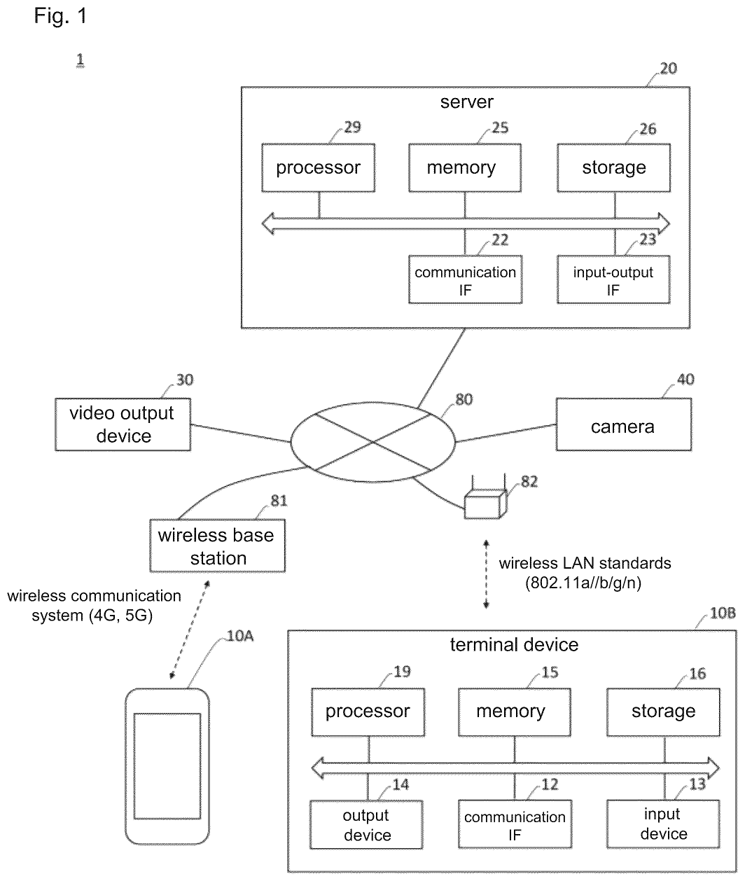

FIG. 1 shows the overall configuration of the video providing system 1. The video providing system displays (shows) video content (images) such as movies and provides viewers with opportunities to view them, captures images of viewers viewing the video content, analyzes the viewers' viewing states from the captured image data, and matches viewers with each other. As shown in FIG. 1, the video providing system 1 consists of multiple terminal devices (terminal device 10A and terminal device 10B are shown in FIG. 1. Hereinafter collectively referred to as “terminal device 10”), a server 20, a video output device 30, and a camera 40. The terminal device 10, the server 20, the video output device 30, and the camera 40 are mutually communicatively connected via a network 80. The network 80 is composed of a wired or wireless network.

The terminal device 10 is a device operated by each user (viewer). Terminal device 10 may be a mobile terminal such as a smartphone, tablet, or other portable device compatible with mobile communication systems. Another example of the terminal device 10 is a portable notebook PC (personal computer) or a laptop PC, for example. As shown in FIG. 1 as terminal device 10B, terminal device 10 is equipped with a communication IF (Interface) 12, an input device 13, an output device 14, a memory 15, a storage 16, and a processor 19.

The terminal device 10 is communicatively connected to the server 20 via the network 80. Terminal device 10 is connected to network 80 by communicating with devices such as wireless base station 81 compatible with communication standards such as 4G, 5G, LTE (Long Term Evolution) and wireless LAN router 82 that supports wireless LAN (Local Area Network) standards such as IEEE (Institute of Electrical and Electronics Engineers) 802.11.

The communication IF 12 is an interface for the terminal device 10 to communicate with external devices and to input and output signals. The input device 13 is a device for accepting input operations from the user (e.g., touch panel, pointing device such as touch pad, mouse, keyboard, etc.). The output device 14 is a device for presenting information to the user (e.g., display, speaker, etc.). The memory 15 is for temporarily storing programs and data processed by the programs, and is a volatile memory such as DRAM (Dynamic Random Access Memory). The storage 16 is a device for storing data, for example, flash memory, HDD (Hard Disc Drive), SSD (Solid State Drive). The processor 19 is hardware for executing the instruction set described in the program, and is composed of arithmetic units, registers, peripheral circuits, etc.

The server 20 is a device that manages information on viewers, video content to be viewed by viewers, captured image data of viewers, and viewing state information of each viewer when viewing video content. The server 20 transmits the image data of the video content to the video output device 30. The server 20 also transmits the matching results between viewers to the viewer's terminal device 10.

The server 20 is a computer connected to the network 80. The server 20 is equipped with a communication IF 22, an input-output IF 23, a memory 25, a storage 26, and a processor 29. The server 20 is communicatively connected to the terminal device 10, the video output device 30, and the camera 40 via the network 80.

The communication IF 22 is an interface for the server 20 to communicate with external devices and to input and output signals. The input-output IF 23 works as an interface with input devices (e.g., pointing devices such as a mouse, keyboard) for accepting input operations from the user and output devices (e.g., displays, speakers, etc.) for presenting information to the user. The memory 25 is used to temporarily store programs and data processed by the programs, and is a volatile memory such as DRAM (Dynamic Random Access Memory). The storage 26 is a device for storing data, for example, flash memory, HDD (Hard Disc Drive), SSD (Solid State Drive). The processor 29 is hardware for executing the instruction set described in the program and consists of arithmetic units, registers, and peripheral circuits.

The video output device 30 is a device that receives video data of video content and displays (shows) it as video according to instructions from the server 20. It is composed, for example, of an LED panel with LED elements arranged around the edges of the frame, an organic EL display, or a liquid crystal display.

The video output device 30 is installed in screening facilities such as movie theaters. The video output device 30 may, for example, be configured as a large-scale vision of several hundred inches by arranging multiple LED panels in parallel, enabling viewing by a large number of viewers at one time. Furthermore, the video output device 30 is not limited to one, but may be configured with the multiple video output devices 30, and the facility equipped with multiple video output devices 30 may be remotely controlled by the single server 20, for example.

The camera 40 is a device for capturing images of viewers watching video content in accordance with instructions from the server 20, and is composed of an imaging device such as a CCD (Charge Coupled Device) image sensor and an A/D converter that converts the captured images into image data consisting of digital signals. The camera 40 may be configured to change the direction in which it takes pictures under the control of the server 20, or it may be configured to move the direction of taking pictures as necessary to enable taking pictures of a wide area.

The camera 40 captures viewers viewing video content as moving images or as still images at predetermined time intervals, and converts the images into moving or still image data. The camera 40 also transmits the captured image data to the server 20. The number of the camera is not limited to one, and multiple camera 40 may be installed in a single facility. The camera is not limited to a single device, but may be configured, for example, by a camera function installed in a mobile terminal such as a smartphone or tablet compatible with the mobile communication system.

<1.1. Configuration of Image Output Device 30 and Camera 40>

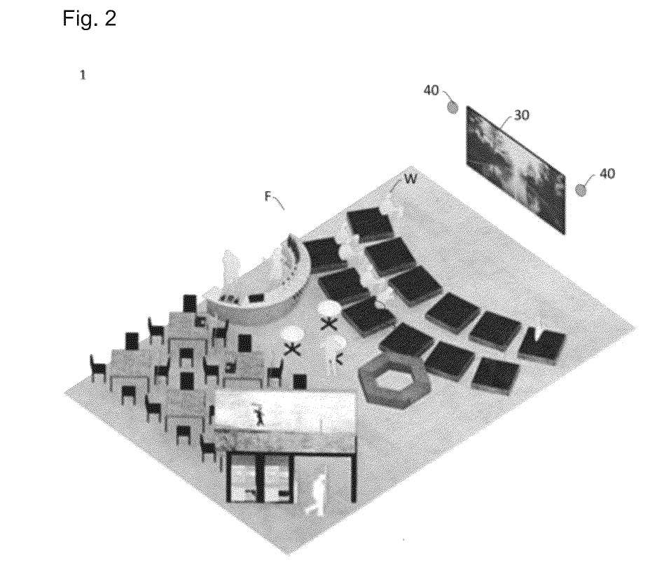

FIG. 2 is a bird's-eye view of an example of the appearance of a facility in which the video providing system 1 is installed. The video providing system 1 is installed in a space where video content is shown, for example, in a movie theater. The video providing system 1 shown in FIG. 2 is an example of the facility where viewers wear audio output devices such as headphones. In this example, the facility is not only for viewing video content, but also for eating, drinking, and other activities.

The video providing system 1 shown in FIG. 2 is provided on the floor F, where a screening space for showing video content and a cafe space are provided together, and the video output device 30 and the camera 40 are installed at designated locations on the floor F (in the upper right direction shown in FIG. 2). On the front side where the video output device 30 displays the video content, there are seats where the viewer W sits to watch the video content. The viewer W wears an audio output device when viewing the video content as described above.

This facility requires viewer W to register as a member in order to enter, and manages viewer attributes of W such as name, sex, age, so that each viewer's movements can be monitored through capturing by the camera 40. The audio output device may be lent by the administrator of the facility. This enables the attribute of viewer W, registered as a member, to correspond with the image data of viewer W captured by camera 40, so that viewing state information for each viewer W's attribute can be grasped.

This configuration allows the viewer W to concentrate on viewing the video content without being bothered by the surroundings. Those who are not viewing the video content, such as users of the cafe space, can eat, drink, or do other activities without being bothered by the sound of the video content.

Since the video output device 30 is composed of an LED panel or the like, it emits light of a certain brightness to the side of the viewer W. Therefore, the camera 40 is able to capture the viewer W with a certain resolution by that light.

The facility where the video providing system 1 is installed is not limited to an enclosed space such as a movie theater, as shown in FIG. 2, but may be a commercial space such as an eat-in corner of a convenience store or an event space. The video providing system 1 may also be installed in a space where a certain level of quietness is ensured, such as a restaurant, a hotel lounge, or a shared space in a housing complex such as an apartment building. Furthermore, the video providing system 1 may be installed in facilities where a certain level of noise is present, such as amusement facilities like pachinko and pachislot parlors, game centers, and amusement facilities.

<1.2. Configuration of Terminal Device 10>

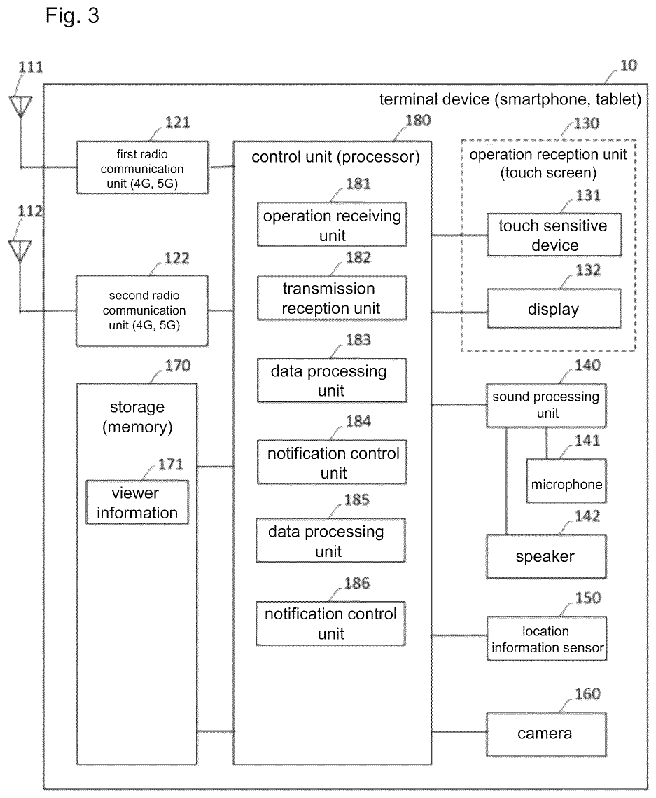

FIG. 3 is a block diagram showing the functional configuration of the terminal device 10 that constitutes the video providing system 1 of the Embodiment 1. As shown in FIG. 2, terminal device 10 has multiple antennas (an antenna 111, an antenna 112), wireless communication sections corresponding to each antenna (a first wireless communication unit 121, a second wireless communication unit 122), an operation reception unit 130 (including a touch sensitive device 131 and a display 132), a sound processing unit 140, a microphone 141, a speaker 142, a location information sensor 150, a camera 160, a storage 170, and a control unit 180. The terminal device 10 also has functions and configurations not specifically shown in FIG. 2 (e.g., a battery for supplying power, a power supply circuit for controlling the supply of power from the battery to each circuit, etc.). As shown in FIG. 3, each block included in terminal device 10 is electrically connected by a bus or other means.

The antenna 111 radiates signals emitted by terminal device 10 as radio waves. The antenna 111 also receives radio waves from the space and gives the received signals to the wireless communication unit 121.

The antenna 112 radiates signals emitted by terminal device 10 as radio waves. The antenna 112 also receives radio waves from the space and gives the received signal to the second wireless communication unit 122.

The first wireless communication unit 121 modulates and demodulates to send and receive signals via the antenna 111 in order for the terminal device 10 to communicate with other wireless devices. The second wireless communication unit 122 modulates and demodulates signals to be transmitted and received via the antenna 112 in order for the terminal device 10 to communicate with other wireless devices. The first wireless communication unit 121 and the second wireless communication unit 122 are communication modules that include tuners, RSSI (Received Signal Strength Indicator) calculation circuits, CRC (Cyclic Redundancy Check) calculation circuits, and high frequency circuits. The first and second wireless communication units 121 and 122 modulate, demodulate, and convert the frequency of the radio signals transmitted and received by the terminal device 10, and provide the received signals to the control unit 180.

The operation reception unit 130 is configured to accept user input operations. Specifically, the operation reception unit 130 is configured as a touch screen and includes a touch sensitive device 131 and the display 132. For example, the operation reception unit 130 may be configured with a keyboard, mouse, or the like.

The touch sensitive device 131 accepts input operations of a user of the terminal device 10. The touch sensitive device 131 detects the position of the user's contact with the touch panel, for example, by using a capacitive touch panel. The touch sensitive device 131 outputs a signal indicating the user's contact position detected by the touch panel to the control unit 180 as an input operation.

The display 132 shows data such as images, video, and text in response to direction by the control unit 180. Display 132 is composed of, for example, an LCD (Liquid Crystal Display) or OLED (Electro-Luminescence) display.

The sound processing unit 140 modulates and demodulates audio signals. The sound processing unit 140 modulates the signal given from the microphone 141 and gives the modulated signal to the control section 180. The sound processing unit 140 also provides the sound signal to the speaker 142. The sound processing unit 140 is composed of a processor for sound processing, for example. The microphone 141 accepts voice input and provides the sound signal corresponding to the voice input to the sound processing unit 140. The speaker 142 converts the sound signal provided by the sound processing unit 140 into voice and outputs the voice to the outside of the terminal device 10.

The location information sensor 150 detects the position of the terminal device 10 and is, for example, a GPS (Global Positioning System) module. The GPS module is a receiving device used in a satellite positioning system. The satellite positioning system receives signals from at least three or four satellites and detects the current position of the terminal device 10 on which the GPS module is mounted based on the received signals.

The camera 160 receives light by a light receiving element and outputs it as a captured image. The camera 160 is, for example, a depth camera capable of detecting the distance from the camera 160 to the object being photographed.

The storage 170 comprises, for example, a flash memory or the like, and stores data and programs used by the terminal device 10. In one example, the storage 170 stores a viewer information 171.

The viewer information 171 is information of a viewer who is registered as a member of the video providing system 1. The viewer information includes information that identifies the viewer registered on the server 20 (viewer ID), name, age, sex, and the like.

The control unit 180 controls the operation of the terminal device 10 by reading a program stored in the storage 170 and executing instructions contained in the program. The control unit 180 is, for example, an application preinstalled in the terminal device 10. The control unit 180 functions as an operation input reception unit 181, a transmission reception unit 182, a data processing unit 183, and a notification control unit 184 by operating according to the program.

The operation input reception unit 181 accepts user input operations to input devices such as the touch sensitive device 131. The operation input reception unit 181 determines the type of operation, such as whether the user operation is a flick, a tap, or a drag (swipe), based on the information of the coordinates of the user's finger or other objects that the user touches against the touch sensitive device 131.

The transmission reception unit 182 processes the terminal device 10 to transmit/receive data to/from an external device, such as the server 20, in accordance with a communication protocol.

The data processing unit 183 processes data inputted by the terminal device 10 according to a program, and outputs the results of the processing to memory, etc.

The notification control unit 184 controls the presentation of information to the user. The notification control section 184 performs processes such as displaying display images on the display 132, outputting sound processing section to the speaker 142, and vibrating the camera 160.

### 1.3. Functional Configuration of Server 20

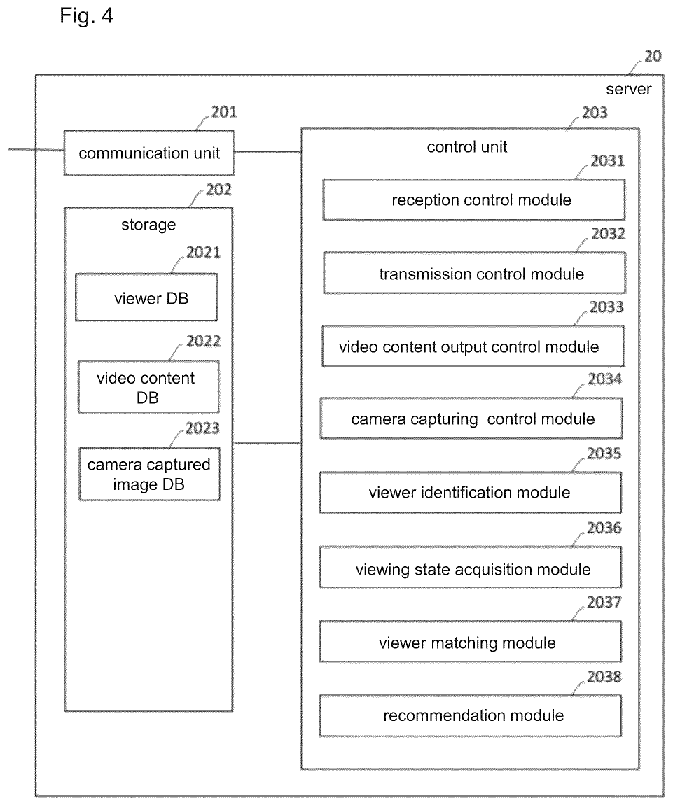

FIG. 4 shows the functional configuration of server 20, which constitutes the video providing system 1 of the Embodiment 1. As shown in FIG. 4, server 20 functions as a communication unit 201, a storage unit 202, and a control unit 203.

The communication unit 201 processes the server 20 to communicate with external devices.

The storage unit 202 stores data and programs used by the server 20. The storage unit 202 stores a viewer database 2021, a video content database 2022, a camera captured image database 2023, and so on.

The viewer database 2021 is a database for keeping information on viewers who use the video providing system 1 and viewing state information when viewing video content for each viewer. The details of the viewer database 2021 are described later. The viewer database 2021 may also contain information on members (including attribute information) registered at the facility.

The video content database 2022 is a database for keeping information on video contents provided in the video providing system 1 and their showing times, i.e., the showing schedule of the video output device 30. The details of the video content database 2022 are described below.

The camera captured image database 2023 is a database for keeping the image data of the camera 40 in chronological order that captured the viewers viewing the video content via the video providing system 1. The image data of the camera 40 are transmitted from the camera 40 to the server 20 with date and time information added, and these signals are stored.

The control unit 203 performs the functions of the following modules by the processor of the server 20 in accordance with the program: a reception control module 2031, a transmission control module 2032, a video content output control module 2033, a camera capturing control module 2034, a viewer identification module 2035, a viewing state acquisition module 2036, a viewer matching module 2037, and a recommendation module 2038.

The reception control module 2031 controls the process by which the server 20 receives signals from external devices according to a communication protocol.

The transmission control module 2032 controls the process by which the server 20 transmits signals to external devices according to a communication protocol.

The video content output control module 2033 controls the process of transmitting image data (including audio data) of video content to the video output device 30 in order to allow viewers to watch the video content. The video content output control module 2033 refers to the video content database 2022 and transmits image data of the video content based on schedule information indicating the date and time the video content is to be shown, as well as control signals so that the video content is shown. The module also transmits information such as data capacity, data format, resolution, etc.

At this time, the video content output control module 2033 may transmit the image data to the video output device 30 in a batch or sequentially in a streaming format. The video content output control module 2033 may also transmit credit information such as the screening time of the video content and the name or title of the creator.

The camera capturing control module 2034 controls the process of capturing viewers with the camera 40 and generating the captured image data. For example, when a new viewer visits the facility shown in FIG. 2, the camera 40 is moved in the capturing direction as necessary, the camera 40 is controlled to capture the viewer, and the camera 40 is tracked and captured according to the viewer's movement, and the captured image data is generated. The image data of the viewer captured by the camera capturing control module 2034 is used for associating with viewer information by the viewer identification module 2035, which will be described later. A motion sensor (not shown in the figure) may be installed near the entrance of the facility shown in FIG. 2 to detect a new viewer, and the camera 40 may be controlled to move its capturing direction in the direction of the detected viewer and continue capturing.

The camera capturing control module 2034 controls the shooting of the viewer by the camera at a resolution that can identify the state of the viewer's eyes and their surroundings. This image data is used to acquire viewing state information by the viewing state acquisition module 2036 described later. Since a frame rate of 50 fps (frames per second) or higher is generally required to acquire image data of the blinking of human eyes, the camera 40 captures images at a frame rate of 50 fps or higher.

The viewer identification module 2035 acquires image data captured by the camera 40, analyzes the image data to identify viewers individually, and controls the process of associating the viewers to the viewer information stored in the viewer database 2021. For example, the viewer identification module 2035 compares the viewer's face image data extracted from the image data captured by the camera 40 with the viewer's face photograph stored in the viewer database 2021, identifies the viewer individually, and associates the viewer to the viewer information. A method for identifying individual viewers employs, for example, image recognition technology for facial images based on machine learning or other known technology.

The viewer identification module 2035 checks the registration information of a member who is a viewer at the entrance of the facility shown in FIG. 2 by querying the viewer information stored in the viewer database 2021. The viewer may be captured by the camera 40 and associated to the viewing state information stored in the viewer database 2021. Furthermore, the viewer identification module 2035 communicates with the terminal device 10 used by a viewer who is a registered member, identifies the positional relationship between the position information from the location information sensor 150 and the image data captured by the camera 40, and identifies each viewer in the viewer information stored in the viewer database 2021. The information of the viewer's terminal device 10 may be queried and associated to the viewer information stored in the viewer database 2021.

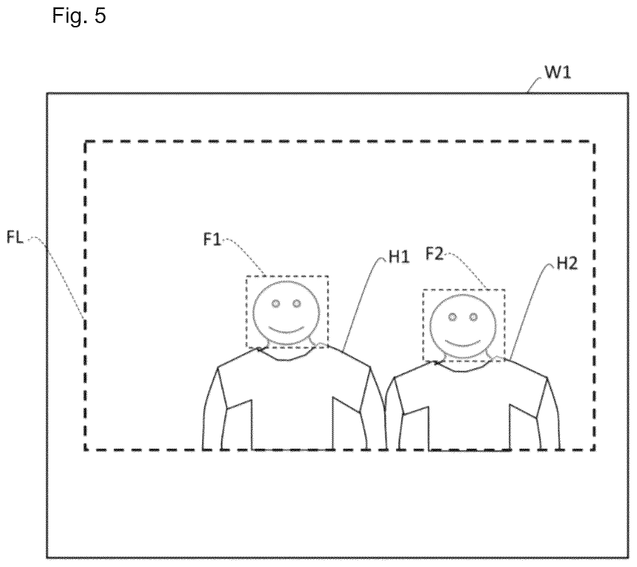

FIG. 5 is a schematic diagram showing the specific method of identifying viewers in the viewer identification module 2035 of FIG. 4. The viewer identification module 2035 identifies and recognizes face images F1 and F2 of viewers H1 and H2 from the frame FL from which the images of viewers H1 and H2 are extracted in the image data W1 shown in FIG. 5, employing a known technique of face recognition. This face recognition is performed, for example, by matching the object in the frame FL with a database of face information held in a database not shown, and determining whether or not it is a face based on the positional relationship between each part, such as eyebrows, eyes, nose, and mouth, and the contour of the object. This enables the attributes of the viewer, such as the viewer's age group and sex, to be determined.

The viewing state acquisition module 2036 acquires image data captured by the camera 40, analyzes the image data to acquire viewing state information indicating the viewing state of the viewer, respectively, and controls the process of associating the viewing state information with the viewer information stored in the viewer database 2021. Here, viewing state information is, for example, information indicating the viewer's lachrymal gland state, the viewer's waking/sleeping state, the viewer's degree of concentration on the video content, the viewer's level of satisfaction with the video content, and the viewer's emotions. The viewing state acquisition module 2036 may, for example, calculate each of these viewing state information as a numerical value indicating the respective information, acquire the respective instantaneous values, and further calculate and acquire the integrated values as a cumulative value. Furthermore, the viewing state acquisition module 2036 may detect outliers from these values of viewing state information using statistical methods and may use them as idiosyncratic information. The viewing state information is acquired in chronological order, for example, by associating the viewing state information with information on the elapsed time since the start of the screening of the video content. Also, for example, the viewing state acquisition module 2036 extracts image data around the eyes of viewers H1 and H2 from the face images F1 and F2 shown in FIG. 5 to detect the state of the viewers' lachrymal gland.

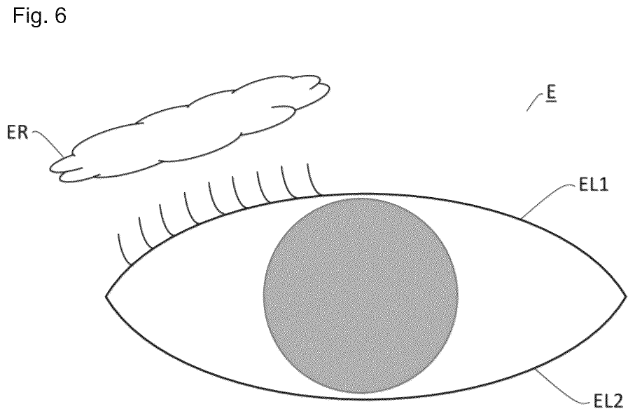

FIG. 6 is a schematic diagram showing the specific method of acquiring the state of the lacrimal gland indicating the viewing state in the viewing state acquisition module 2036 of FIG. 4. The viewing state acquisition module 2036 detects the state of the lacrimal gland ER in the eye E information from the image data around the eye E shown in FIG. 6. Generally, when a person feels sad and is about to shed tears, the lacrimal gland ER secretes lachrymal fluid, which causes the lacrimal gland ER to become swollen. Detecting this can determine that the viewer's emotion is in a sad state. Therefore, the viewing state acquisition module 2036 acquires, as viewing state information, the percentage of swelling of the lacrimal gland ER compared to the normal state (e.g., at the start of viewing the video content), and based on this value, it quantifies and acquires that the viewer's emotion is in a sad state.

As another example, the viewing state acquisition module 2036 analyzes the frequency of opening and closing of the upper eyelids EL1 and lower eyelids EL2 shown in FIG. 6. Generally, when a person is concentrating on something, the opening and closing of the eyes tends to decrease. Therefore, analyzing the frequency of opening and closing of the eyes can be used to estimate the viewer's degree of concentration. Also, when a viewer is concentrating on watching video content, the level of satisfaction is considered to be high. Therefore, the viewing state acquisition module 2036 acquires the frequency (number of times) of opening and closing of the upper eyelids EL1 and lower eyelids EL2 as viewing state information, and based on these values, the viewer's level of concentration and satisfaction with the video content are quantified and acquired. Furthermore, if the upper eyelids EL1 and lower eyelids EL2 shown in FIG. 6 are closed for more than a certain period of time, the viewer is not awake and is considered to be in a sleeping state. Thus, the viewing state acquisition module 2036 acquires the time when the upper eyelids EL1 and lower eyelids EL2 are open or closed as viewing state information, and based on this numerical value, acquires the viewer's waking/sleeping state (time).

As another example, the viewing state acquisition module 2036 analyzes the facial expressions of each viewer H1, H2 from the face images F1, F2 shown in FIG. 5. The viewing state acquisition module 2036 analyzes the facial expressions of viewers H1 and H2 from the face images F1 and F2 shown in FIG. 5 to read the viewer's emotions, etc., using a known technology such as the Facial Action Coding System (FACS). This FACS is an artificial intelligence technology for recognizing human emotions, which assigns a code called an action unit to each facial expression muscle, and identifies the emotion at that time in response to the intensity and balance of the action unit that changes in response to the movement of the facial expression muscle. Thus, the viewing state acquisition module 2036 acquires the state of the facial expressions of the face images F1 and F2 as viewing state information, and acquires the viewer's emotion based on the values indicating the state of these facial muscles.

The viewer matching module 2037 controls the matching process between viewers who are simultaneously viewing the video content at the facility shown in FIG. 2 based on the viewing state information acquired by the viewing state acquisition module 2036. For example, the viewer matching module 2037 matches two or more viewers whose emotions fluctuated during an approximate time period (same scene) in the video content they were viewing, or two or more viewers whose satisfaction levels with the video content as a whole are similar. The viewer matching module 2037 may be configured to encourage matching among viewers by presenting a ranking of the concentration and satisfaction levels of viewers of the video content to all viewers so that the viewers can access the ranking among themselves. The concentration and satisfaction levels may be a value for the entire video content or for a moment in the video.

The viewer matching module 2037 matches two or more viewers who are similar in the type of emotion (fun, excited, happy, sad, etc.) toward the video content they were viewing. Furthermore, the viewer matching module 2037 matches two or more viewers who have similar levels of concentration and satisfaction with the video content they were viewing.

The recommendation module 2038 controls the process of recommending the matching results by the viewer matching module 2037 to the matched viewers, respectively. Specifically, the recommendation module 2038 sends a recommendation notice to the terminal device 10 of the matched viewers. At this time, the recommendation module 2038 may notify viewing state information indicating for what reason the viewers were matched (e.g., the viewer showed a similar emotional change in a given scene of the video content, or the viewer's satisfaction level with the video content), or it may notify viewer information.

For example, the recommendation module 2038 notifies the location information where the matched partner viewer is in the facility shown in FIG. 2. The location information is the seat number in a facility such as a movie theater, or a table number in a cafe space such as the one shown in FIG. 2. The recommendation module 2038 may also display (present) the layout information (floor plan) of the facility shown in FIG. 2 to the terminal device 10, and display (present) the location where the matched other viewer is in the layout information.

The recommendation module 2038 also notifies the matched viewers to move to a predetermined location in or near the facility (e.g., a lobby in the facility) to meet. Furthermore, the recommendation module 2038 may display (present) the layout information (a floor plan) of the facility or neighborhood shown in FIG. 2 to the terminal device 10, and display (present) the locations where the matched viewers move to each other in the layout information.

The recommendation module 2038 may not only encourage the matched viewers to communicate with each other on the spot, but may also notify contact information and encourage them to communicate (e.g., non-face-to-face). The contact information may be an e-mail address, account information for a variety of social networking services, or account information provided by the video providing system 1 (e.g., an exchange site). Furthermore, the recommendation module 2038 may also recommend video content viewed by the matched partner viewer, may recommend video content viewed by the partner viewer after notification of the matching information, and may recommend the date and time information of the video content that the partner viewer is scheduled to view and encourage viewing.

The recommendation module 2038 may also display (present) the viewer's acceptance or refusal of the matching notification, specifically, the input to accept or refuse the meeting, to the terminal device 10. In this case, the recommendation module 2038 may notify the other viewer upon receipt of the acceptance or refusal input.

### 2. Data Structure

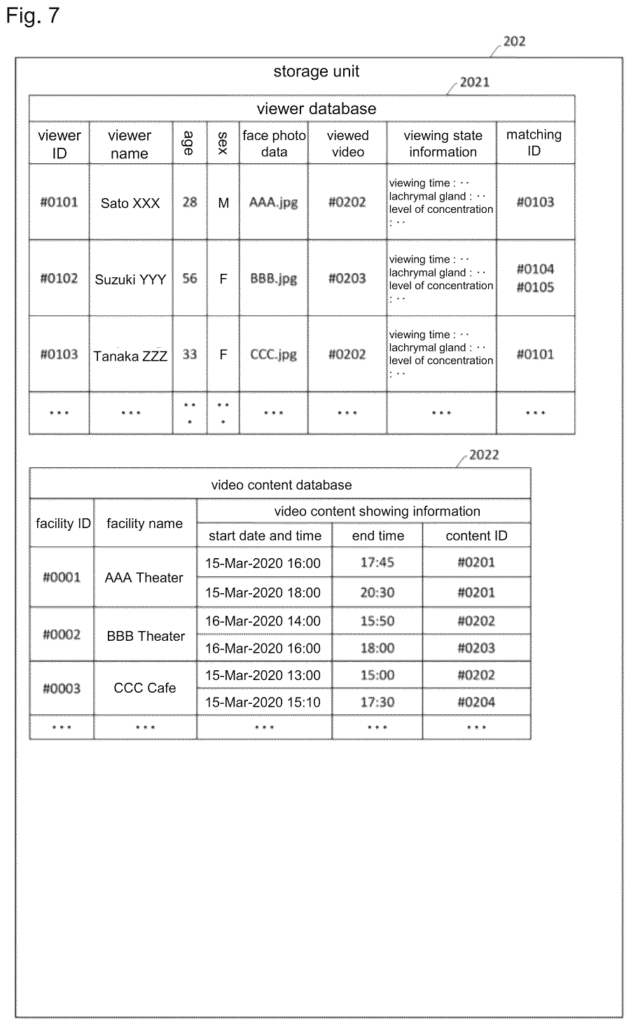

FIG. 7 shows the data structure of the viewer database 2021 and the video content database 2022 stored by the server 20.

As shown in FIG. 7, the records in viewer database 2021 contain the item “viewer ID,” the item “viewer name,” the item “age,” the item “sex,” the item “photo data,” the item “viewing video,” the item “viewing state information,” the item “matching ID,” etc., respectively.

The item “viewer ID” is information that identifies each viewer who is registered as a member of the facility using the video providing system 1.

The item “viewer name” is information that identifies the name of the viewer who is registered as a member of the facility using the video providing system 1.

The item “age” indicates the age of the viewer who is registered as a member of the facility using the video providing system 1.

The item “sex” is information indicating the sex of the viewer who is registered as a member at the facility using the video providing system 1.

The item “face photo data” indicates the photographed image data of the face of the viewer who is registered as a member of the facility using the video providing system 1.

The item “viewed video” is information that identifies each video content viewed by the viewer using the video providing system 1, and corresponds to the item “content ID” in the video content database 2022 described below. The information after this item in the viewer database 2021 is stored as many times as the number of video contents viewed by the viewer.

The item “viewing state information” is viewing state information when the viewer viewed the video content shown in the item “viewing video” using the video providing system 1, and information such as viewing time, lachrymal gland state, and concentration level is stored. The viewing state information is information acquired by the viewing state acquisition module 2036.

The item “matching ID” is information that identifies each viewer matched to that viewer using the video providing system 1, and corresponds to the item “viewer ID.

The viewing state acquisition module 2036 of the server 20 updates the viewer database 2021 each time a viewer views video using video providing system 1 and acquires viewing state information of the viewer. The viewer matching module 2037 updates the viewer database 2021 each time viewers are matched with each other.

The records in the video content database 2022 contain the item “facility ID,” the item “facility name,” the item “content screening information,” etc., respectively.

The item “facility ID” is information that identifies each facility in which the video providing system 1 is installed. When multiple video output devices 30 are installed in one facility and each of the devices shows different video contents, the item “facility ID” with different values is assigned and managed separately.

The item “facility name” is information indicating the name of the facility where the video providing system 1 is installed.

The item “content showing information” is information on the schedule of showing movies and other video contents to be shown at the facility using the video providing system 1, and specifically includes the items “start date and time”, “end time”, and “contents ID”, etc. As shown in FIG. 7, one or more items of “content showing information” are stored in chronological order for one item of “facility ID”.

The item “start date and time” is information indicating the start date and time of video content showing information at the facility.

The item “end time” indicates the end time of the video content showing information at the facility.

The item “content ID” is information that identifies each of the video content showing information at the facility.

The server 20 updates the video content database 2022 as it receives input of video content showing information from the facility manager.

### 3. Operation

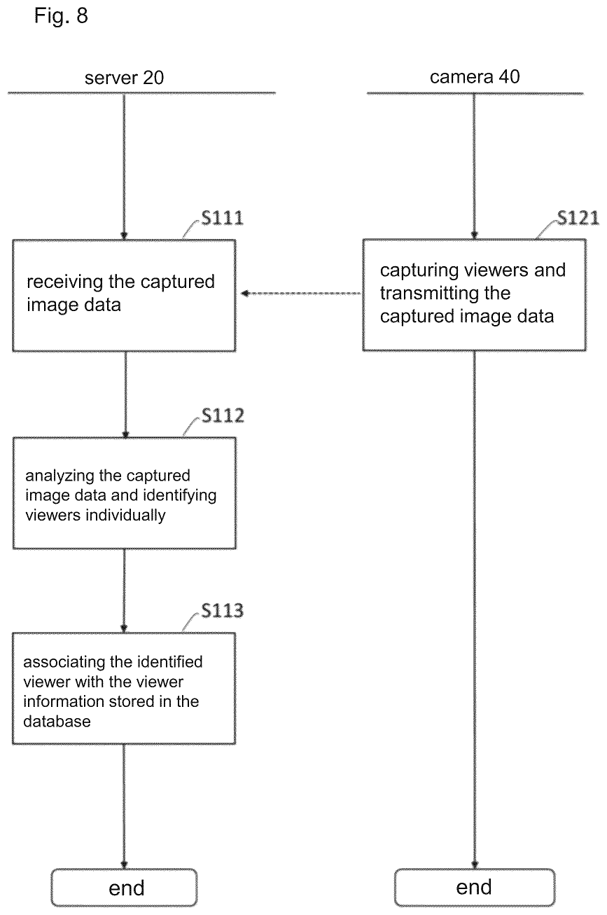

Referring to FIGS. 8 through 10, the processes of viewer identification, acquisition of viewing status, and viewer matching by the video providing system 1 of the Embodiment 1 are described.

FIG. 8 is a flowchart showing an example of the flow of viewer identification processing by the video providing system 1 of in the Embodiment 1.

In step S121, the camera 40 captures viewers and generates the captured image data. For example, when a new viewer comes to the site, the camera 40 moves the direction of capturing images as necessary to track and capture images according to the movement of the viewer. The camera 40 transmits the captured image data to the server 20.

In step S11, the camera capturing control module 2034 of the server 20 receives the image data transmitted from the camera 40 via the communication unit 201. The camera capturing control module 2034 also stores the received image data in the camera captured image database 2023.

In step S112, the viewer identification module 2035 of server 20 analyzes the captured data received in step S111 and identifies viewers individually.

In step S113, the viewer identification module 2035 of the server 20 associates the viewer identified in step S112 with the viewer information stored in the viewer database 2021. For example, the viewer identification module 2035 compares the viewer's face image data extracted from the image data captured by the camera 40 with the viewer's face photo stored in the viewer database 2021, identifies the viewer individually, and associates the viewer with the viewer information.

As described above, the video providing system 1 captures viewers with the camera 40, identifies viewers individually, and associates them to viewer information. In this way, viewers are individually traced and tied to subsequent viewing state information acquisition and matching processes.

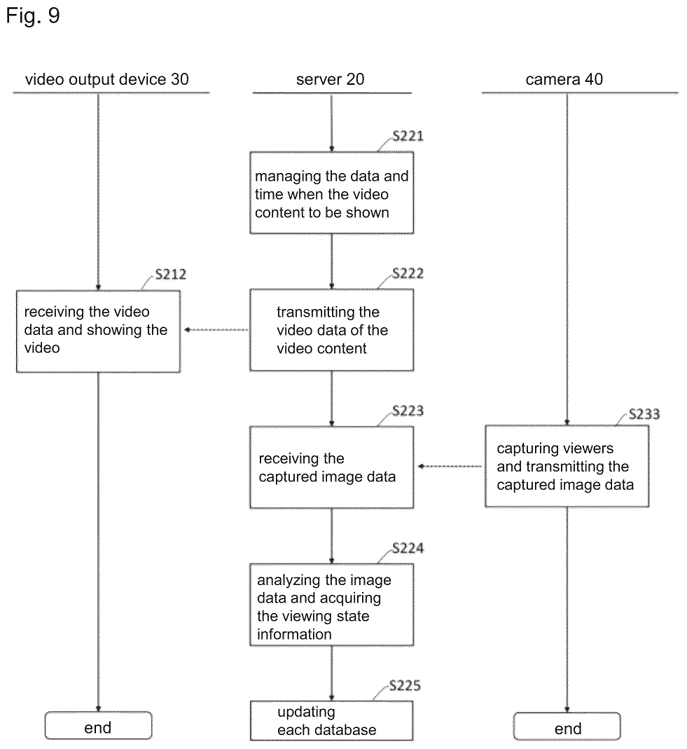

FIG. 9 is a flowchart showing an example of the process of acquiring the viewing status by the video providing system 1 of the Embodiment 1.

In step S221, the video content output control module 2033 of the server 20 refers to the video content database 2022 to manage the date and time when the video content is to be shown. At the time when the video contents should be transmitted for showing, the video contents output control module 2033 proceeds to the process of step S222.

In step S222, the video content output control module 2033 of the server 20 transmits the video data of the video content to the video output device 30 via the communication unit 201 in order to allow the viewer to view the video content.

In step S212, the video output device 30 receives the video content video data transmitted by the server 20 and shows it as video.

In step S233, the camera 40 captures viewers viewing the video and generates the captured image data. The camera 40 transmits the captured image data to the server 20.

In step S223, the camera capturing control module 2034 of the server 20 receives the image data transmitted from the camera 40 via the communication unit 201. The camera capturing control module 2034 also stores the received image data in the camera captured image database 2023.

In step S224, the viewing state acquisition module 2036 of the server 20 analyzes the image data received in step S223 to acquire the viewing state information of the viewers, respectively, and associates the viewing state information with the viewing state information stored in the viewer database 2021. For example, the viewing state information is associated with the elapsed time information from the start of video content showing information and is acquired in chronological order.

In step S225, the viewing state acquisition module 2036 of the server 20 stores the viewing state information in the viewer database 2021.

Thus, the video providing system 1 transmits the video data of the video content to the video output device 30 at a predetermined time. The video output device 30 shows the video data as an image. The camera 40 captures viewers viewing the video and acquires viewing state information from the captured image data. This enables the response of the viewer to the video content to be linked to the viewer information.

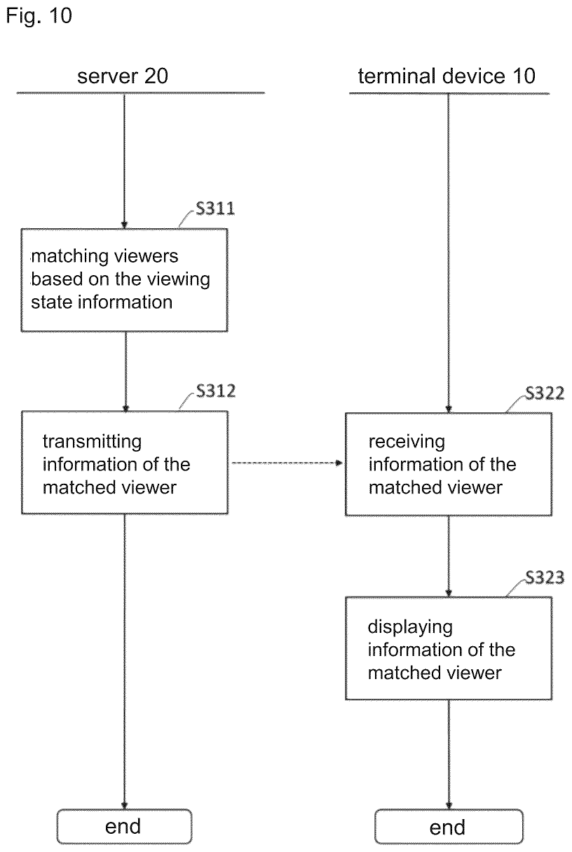

FIG. 10 is a flowchart showing an example of the flow of the viewer matching process by the video providing system 1 of the Embodiment 1.

In step S311, the viewer matching module 2037 of the server 20 matches viewers who are simultaneously viewing video content at the facility shown in FIG. 2 based on the viewing state information acquired in step S224. For example, the viewer matching module 2037 matches two or more viewers whose emotions fluctuated during an approximate time period (same scene) in the video content they are viewing.

In step S312, the recommendation module 2038 of server 20 transmits the matching results acquired in step S311 to the terminal device 10 of the matched viewer via the communication unit 201 as a recommendation notification.

In step S322, the transmission reception unit 172 of the terminal device 10 receives the matching results acquired from the server 20.

In step S323, a notification control unit 174 of the terminal device 10 displays the received matching results acquired on the display 132.

Thus, the server 20 of the video providing system 1 matches viewers who are viewing the same video content at the same time in a facility such as a movie theater based on the viewing state information of the viewers, and notifies the viewers of the matching results. This enables viewers to sympathize with each other by connecting viewers who have viewed the same video content and shown similar reactions to each other.

### 4. Screen Example

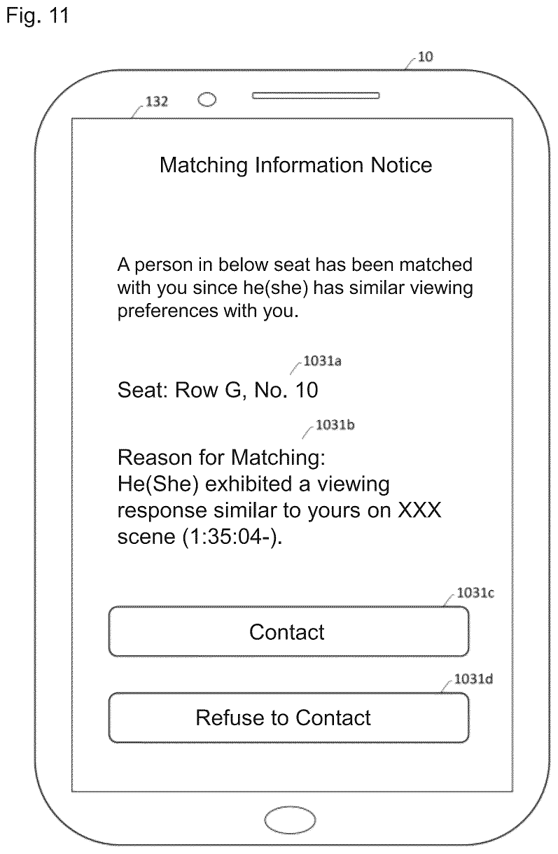

The following is a screen example of the viewer matching process using the video providing system 1, referring to FIGS. 11 through 13.

FIG. 11 shows an example of a screen of the terminal device 10 notifying the matching partner in the viewer matching process. The screen example in FIG. 11 shows a screen displaying the notification details to the matched viewer by the recommendation module 2038 of the server 20. This corresponds to step S323 in FIG. 10.

As shown in FIG. 11, the display 132 of the terminal device 10 shows the matching results acquired by the viewer matching module 2037, including a location information 1031a, which is the seat number of the viewer being matched with in the facility such as a movie theater, and a matching reason 1031b, which is the reason for matching by the viewer matching module 2037, a permission notification button 1031c, which notifies that the matching party is allowed to be contacted, and a refusal notification button 1031d.

The viewer who is notified of the matching results can know that there is a viewer in the location information 1031a who shares the same impressions of the video content he/she was viewing. If the viewer wishes to meet with him/her, the viewer can press the permission notification button 1031c, and if the viewer does not wish to meet, the viewer can press the refusal notification button 1031d. The permission notification button 1031c and the refusal notification button 1031d facilitate notification to the matching partner.

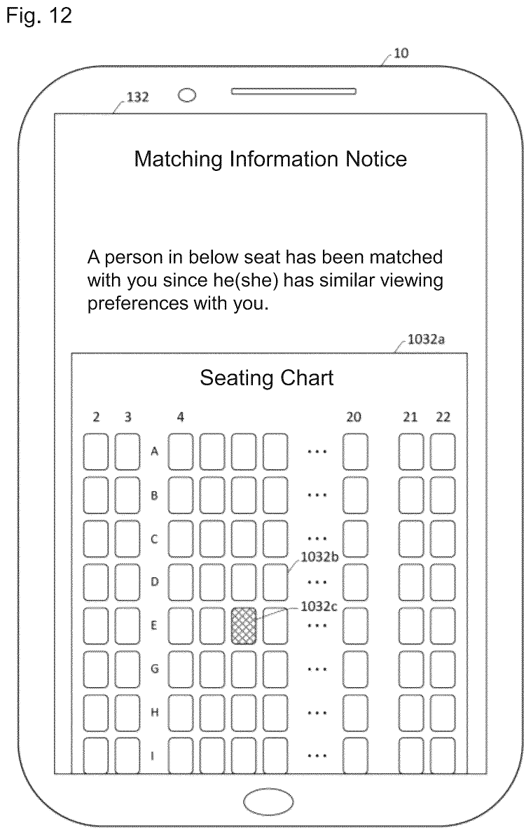

FIG. 12 shows another screen example of the terminal device 10 notifying the matching party in the viewer matching process. The screen example in FIG. 12 shows an example of a screen displaying the contents of the notification of recommendations to the matched viewer concerned by the recommendation module 2038 of the server 20. This corresponds to step S323 in FIG. 10.

As shown in FIG. 12, on the display 132 of the terminal device 10, a seating chart 1032a showing layout information of a facility such as a movie theater, a seat information 1032b showing the position of seats in the layout information, and a seat information 1032c showing the position of seat where the matched viewer, acquired as a result by the viewer matching module 2037, is located in the viewer layout information are displayed. Displaying the location information of the matching viewer in the layout information like this makes it easier for the viewer to know the position of the matching viewer.

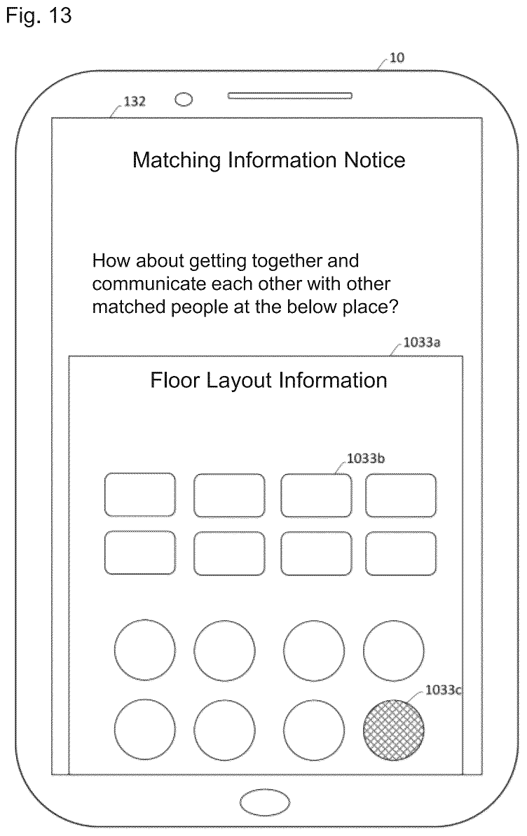

FIG. 13 shows a screen example of the terminal device 10 that notifies meeting place in the viewer matching process. The screen example in FIG. 13 shows a screen displaying the recommendation notification contents to the matched viewer by the recommendation module 2038 of the server 20. This corresponds to step S323 in FIG. 10.

As shown in FIG. 13, the display 132 of the terminal device 10 displays a seating chart 1033a showing layout information of a facility such as a movie theater, a seat information 1033b showing the position of seats in the layout information, and a seat information 1033c showing the position where the matched viewers, acquired as a result by the viewer matching module 2037, meet in the layout information. Displaying the location of the meeting with the matched viewer in such layout information makes it easier for viewers to know the location of the meeting.

<Brief Summary>

As described above, in this Embodiment, a camera is used to capture a viewer viewing video content, and the face of each viewer is identified from the captured image data and associated with the viewing state information. This enables viewer behavior tracking, that is, understanding the viewer's behavior.

The system also analyzes facial expressions, eye conditions, and lacrimal gland conditions from the state of the viewer's face in the image data to acquire viewing state information indicating the viewer's state of waking/sleeping, the viewer's level of concentration on the video content, level of satisfaction, and emotions, and associates this information with the viewer information. Therefore, information indicating viewer responses to video content can be associated with viewer information. Information of viewer responses to video content can be acquired for each viewer attribute included in viewer information, enabling analysis for each viewer attribute.

Furthermore, based on the viewing state information of the viewers, matching is performed between viewers who are simultaneously viewing video content at facilities such as movie theaters, and the result is notified to the viewers. This configuration enables to connect and symphasize viewers with each other, who have similar impressions of the same movie. This provides new value to movie theaters.

### Embodiment 2

The following is a description of another embodiment of the video providing system 1.

<1. Overall Configuration of the Video Providing System 1>

FIG. 13 shows the functional configuration of the server 20, which constitutes the video providing system 1 of the Embodiment 2. Since the overall configuration of the video providing system 1 and the configuration of the terminal device 10 in the Embodiment 2 are the same as those in the Embodiment 1, they will not be repeatedly explained. The configuration of server is the same to that of the Embodiment 1, except that it is equipped with a video content evaluation module 2039, as shown in FIG. 13. The function of the video content evaluation module 2039 in the Embodiment 2 is described hereinafter.

The video content evaluation module 2039 controls the process of generating evaluation information for the target video content based on the viewing state information acquired by the viewing state acquisition module 2036. As described above, the viewing state information includes the level of concentration on the video content, the level of satisfaction with the video content, and the emotions of the viewer. Based on this information, evaluation information for the relevant video content is generated.

For example, when a certain number of viewing state information of viewers who have viewed a certain video content can be acquired, it is possible to know at which scenes the viewers who have viewed the said video content have changed their emotions or a level of concentration, etc. This enables grasping the level of concentration, level of satisfaction, and emotional trends of the viewers who have viewed the relevant video content and evaluating the video content. In addition, such evaluation can be performed based on the attributes of the viewer. The video content evaluation module 2039 generates evaluation information for a video content.

The evaluation information of the video content may be acquired in correspondence with the elapsed time of the video content. Such evaluation information corresponding to the elapsed time enables understanding of the most moving or exciting scenes by the viewers, and can be utilized for promotion of the video content.

<2. Data Structure>

The data structure of the Embodiment 2 is the same as that of the Embodiment 1.

<3. Operation>

The operation of the Embodiment 2 is the same as that of the Embodiment 1.

<Brief Summary>

As described above, according to this Embodiment, evaluation information for the target video content is generated based on the viewing state information of the viewers of the video content. This enables analysis of promotion and other methods based on the evaluation of the video content.

The certain embodiments have been described above, but they can be implemented in various other forms, and can be implemented with various omissions, substitutions, and modifications. These embodiments and variations, as well as omissions, substitutions, and modifications, are included within the technical scope of the claims and their equivalents.

### APPENDIX

The description of each of the above embodiments is appended below.

### Appendix 1

A program for execution by a computer equipped with a processor and a memory; wherein the program is configured to cause the memory to store viewer information that is registered as a viewer who views a video at a facility where the video is shown; and wherein the program is configured to cause the processor to execute a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.

### Appendix 2

The program according to appendix 1, wherein the program is configured to further causes the processor to execute the step of recommending the viewer information regarding the matched viewers to the matched other viewers, respectively.

### Appendix 3

The program according to appendix 2, wherein the program is configured to notify the matched viewers of their location in the facility to the other matched viewers, respectively.

### Appendix 4

The program according to appendix 3, wherein the program is configured to provide a layout information of the facility and provides a location information of the matched viewer in the layout information.

### Appendix 5

The program according to appendix 2, wherein the program is configured to recommend each of the matched viewers to move to a location in or near the facility.

### Appendix 6

6. The program according to appendix 5, wherein the program is configured to present the layout information of the facility and the location of the destination where the each of the matched viewers move to.

### Appendix 7

The program according to any one of appendixes 2 to 6, wherein the program is configured to notify the viewing state information of the viewer along with the viewer information.

### Appendix 8

The program according to any one of appendixes 2 to 7, wherein the program is configured to notify the information of the video viewed by the viewer along with the viewer information.

### Appendix 9

The program according to any one of appendixes 2 to 8, wherein the program is configured to further causes the processor to execute the step of receiving information regarding acceptance or refusal of the matching and notifying each of the matched viewers of the other viewers about the information.

### Appendix 10

The program according to any one of appendixes 1 to 9, wherein the program is configured to acquire the viewing state information in chronological order by associating with information on the elapsed time since the start of the showing of the video.

### Appendix 11

The program according to any one of appendixes 1 to 10, wherein the program is configured to analyze the image data to acquire viewing state information comprising one or more of a lacrimal gland state of the viewer, an waking/sleeping state of the viewer, a level of concentration of the viewer on the video, a level of satisfaction of the viewer with the video, and an emotional state of the viewer.

### Appendix 12

The program according to any one of claim 11, wherein the program is configured to calculate and acquire a lacrimal gland state of the viewer, an waking/sleeping state of the viewer, a level of concentration of the viewer on the video, a level of satisfaction of the viewer with the video, and an emotional state of the viewer as numerical values, respectively.

### Appendix 13

The program according to any one of appendixes 1 to 12, wherein the program is configured to further causes the processor to generate evaluation information of the video based on the viewing state information for each viewer.

### Appendix 14

The program according to any one of appendixes 1 to 13, wherein the program is configured to perform matching among the viewers at the facility based on the evaluation information of the video.

### Appendix 15

An information processing device comprising a control unit and a memory unit; wherein the memory unit stores viewer information that is registered as a viewer who views a video at a facility where the video is shown; and wherein the control unit executes a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.

### Appendix 16

A method for execution by a computer provided with a processor and a memory, wherein the method comprises a memory storing viewer information that is registered as a viewer who views a video at a facility where the video is shown; and wherein the method comprises a processor executing a step of identifying each viewer individually from image data of a plurality of viewers viewing the video and associating each viewer with the viewer information; a step of analyzing the image data for each viewer, acquiring viewing state information indicating the viewing state of each viewer, and associating each viewer with the viewer information; and a step of matching the viewers at the facility based on the viewing state information for each viewer.
10: terminal device
20: server
80: network
130: operation reception unit
171: viewer information
22: communication IF
23: input-output IF
25: memory
26: storage
29: processor
201: communication unit
202: storage unit
2021: viewer database
2022: video content database
2023: camera captured image database
203: control unit
301: communication unit
302: memory
303: control section

1. A non-transitory computer-readable storage medium storing a program for causing a computer equipped with a processor and a memory to execute processing comprising:
causing the memory to store viewer information that is registered as a viewer who views a video at a facility where the video is shown; and
causing the processor to execute:
identifying each viewer individually from image data of a plurality of viewers viewing the video and associating each viewer with the viewer information;
analyzing the image data for each viewer, acquiring viewing state information indicating the viewing state of each viewer, and associating each viewer with the viewer information;
matching the viewers at the facility based on the viewing state information for each viewer;
acquiring location information from the location information sensor of the terminal device used by the viewer, identifying the viewer individually from the location information from the location information sensor and the location information in the image data, and acquiring the viewer's location information in the facility; and
recommending the viewer information regarding the matched viewers to the matched other viewers, respectively, and notifying the matched viewers of their location in the facility and of the reason of the viewers were matched to the other matched viewers.

2. (canceled)

3. (canceled)

4. The non-transitory computer-readable storage medium storing a program according to claim 1, the processing executed by the program comprises providing a layout information of the facility and providing a location information of the matched viewer in the layout information.

5. (canceled)

6. (canceled)

7. The non-transitory computer-readable storage medium storing a program according to claim 4, the processing executed by the program comprises notifying the viewing state information of the viewer along with the viewer information.

8. The non-transitory computer-readable storage medium storing a program according to claim 4, the processing executed by the program comprises notifying the information of the video viewed by the viewer along with the viewer information.

9. The non-transitory computer-readable storage medium storing a program according to claim 4, the processing executed by the program comprises further causing the processor to execute the receiving information regarding acceptance or refusal of the matching and notifying each of the matched viewers of the other viewers about the information.

10. The non-transitory computer-readable storage medium storing a program according to claim 1, the processing executed by the program comprises acquiring the viewing state information in chronological order by associating with information on the elapsed time since the start of the showing of the video.

11. The non-transitory computer-readable storage medium storing a program according to claim 1, the processing executed by the program comprises analyzing the image data to acquire viewing state information comprising one or more of a lacrimal gland state of the viewer, an waking/sleeping state of the viewer, a level of concentration of the viewer on the video, a level of satisfaction of the viewer with the video, and an emotional state of the viewer.

12. The non-transitory computer-readable storage medium storing a program according to claim 11, the processing executed by the program comprises calculating and acquiring a lacrimal gland state of the viewer, an waking/sleeping state of the viewer, a level of concentration of the viewer on the video, a level of satisfaction of the viewer with the video, and an emotional state of the viewer as numerical values, respectively.

13. The non-transitory computer-readable storage medium storing a program according to claim 1, the processing executed by the program comprises further causing the processor to generate evaluation information of the video based on the viewing state information for each viewer.

14. The non-transitory computer-readable storage medium storing a program according to claim 1, the processing by the program comprises performing matching among the viewers at the facility based on the evaluation information of the video.

15. An information processing device comprising a control unit and a memory unit;
wherein the memory unit stores viewer information that is registered as a viewer who views a video at a facility where the video is shown; and
wherein the control unit executes
identifying each viewer individually from image data of a plurality of viewers viewing the video and associating each viewer with the viewer information;
analyzing the image data for each viewer, acquiring viewing state information indicating the viewing state of each viewer, and associating each viewer with the viewer information;
matching the viewers at the facility based on the viewing state information for each viewer;
acquiring location information from the location information sensor of the terminal device used by the viewer, identifying the viewer individually from the location information from the location information sensor and the location information in the image data, and acquiring the viewer's location information in the facility; and
recommending the viewer information regarding the matched viewers to the matched other viewers, respectively, and notifying the matched viewers of their location in the facility and of the reason of the viewers were matched to the other matched viewers.

16. A method for execution by a computer provided with a processor and a memory,
wherein the method comprises a memory storing viewer information that is registered as a viewer who views a video at a facility where the video is shown; and
wherein the method comprises a processor executing
identifying each viewer individually from image data of a plurality of viewers viewing the video and associating each viewer with the viewer information;
analyzing the image data for each viewer, acquiring viewing state information indicating the viewing state of each viewer, and associating each viewer with the viewer information;
matching the viewers at the facility based on the viewing state information for each viewer;
acquiring location information from the location information sensor of the terminal device used by the viewer, identifying the viewer individually from the location information from the location information sensor and the location information in the image data, and acquiring the viewer's location information in the facility; and
recommending the viewer information regarding the matched viewers to the matched other viewers, respectively, and notifying the matched viewers of their location in the facility and of the reason of the viewers were matched to the other matched viewers.
